(19) United States
(12) Patent Application Publication
(10) Pub. No.: US 2009/0035187 A1
(43) Pub. Date: Feb. 5, 2009

(54) Microarray assay devices and methods of making and using the same

(76) Inventors: Arthur Schleifer, Portola Valley, CA (US); Richard Paul Tella, Sunnyvale, CA (US); William D. Fisher, San Jose, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/888,932

(22) Filed: Aug. 2, 2007

(51) Int. Cl. B01L 3/00; B23P 17/00

(52) U.S. Cl. 422/102; 29/592

(57) ABSTRACT

Aspects of the invention include systems for producing microarray assay devices. Further aspects of the invention include assembled microarray assay devices, as well as methods of assembling the devices and methods of using the assembled devices.

### INTRODUCTION

Array assays between surface bound binding agents or probes and target molecules in solution may be used to detect the presence of particular biopolymers. The surface-bound probes may be oligonucleotides, peptides, polypeptides, proteins, antibodies or other molecules capable of binding with target molecules in solution. Such binding interactions are the basis for many of the methods and devices used in a variety of different fields, e.g., genomics (in sequencing by hybridization, SNP detection, differential gene expression analysis, comparative genome hybridization (CGH), location analysis (e.g., ChIP-Chip analysis) identification of novel genes, gene mapping, fingerprinting, etc.) and proteomics.

One example of an array assay method involves biopolymeric probes immobilized in an addressable array on a surface of a solid substrate, such as a glass slide. A liquid sample at least suspected of containing analytes of interest (i.e., targets) that bind with the attached probes is placed in contact with the array displaying surface, covered with another substrate to form an assay area and placed in an environmentally controlled chamber, such as an incubator or the like. If present, the targets in the liquid sample bind to the complementary probes on the substrate to form a binding complex. The pattern of binding by target molecules to biopolymer probe features or spots on the substrate surface produces a pattern on the surface of the substrate and provides desired information about the sample. For detection purposes, the target molecules may be labeled with a detectable tag, such as a fluorescent tag, chemiluminescent tag or radioactive tag. The resultant binding interaction or complexes of binding pairs are then detected and read (i.e., interrogated), for example by optical means, although, other methods may also be used. For example, laser light may be used to excite fluorescent tags, generating a signal only in those spots on the biochip that have a target molecule and thus a fluorescent tag bound to a probe molecule. This pattern may then be digitally scanned for computer analysis.

### SUMMARY OF THE INVENTION

Aspects of the invention include systems for producing microarray assay devices. The systems include a base support, a well-defining structure and a first compression element, where these components are configured to be assembled together with a planar microarray to produce a microarray assay device. The resultant microarray assay device includes two or more distinct fluid-tight wells which have a bottom surface that is a region of the top surface of the planar microarray. Embodiments of the systems further include a cover and a second compression element. Further aspects of the invention include assembled microarray assay devices, as well as methods of assembling the devices and methods of using the assembled devices.

### BRIEF DESCRIPTIONS OF THE FIGURES

FIG. 1 provides a view of an end portion of a base support of a system according to an embodiment of the invention.

FIG. 2 provides a view of a planar microarray that can be employed with embodiments of the systems of the invention.

FIG. 3 provides another view of the base support portion shown in FIG. 1.

FIG. 4 provides another view of the base support portion shown in FIG. 1, with the planar microarray of FIG. 2 positioned therein.

FIG. 5A provides a view of a gasket component of a well-defining structure according to an embodiment of the invention.

FIGS. 5B to 5D provide various views of a rigid wall structure component of a well-defining structure according to an embodiment of the invention.

FIG. 6 provides a view of the base support portion and array shown in FIG. 3. where a well-defining structure produced by the components shown in FIGS. 5A to FD is positioned on the upper surface of the array.

FIGS. 7A and 7B provide various views of a compression element employed in embodiments of the invention.

FIGS. 8A and 8B provide various views of assembled array assay devices according to an embodiment of the invention.

FIG. 9 provides a view of the device shown in FIG. 8, where a cover and second compression element has been included.

FIGS. 10A to 10F provides digital images of various components of a system according to an embodiment of the invention.

### DEFINITIONS

The term “polymer” means any compound that is made up of two or more monomeric units covalently bonded to each other, where the monomeric units may be the same or different, such that the polymer may be a homopolymer or a heteropolymer. Exemplary polymers include peptides, polysaccharides, nucleic acids and the like, where the polymers may be naturally occurring or synthetic.

The term “peptide” as used herein refers to any polymer compound produced by amide formation between an α-carboxyl group of one amino acid and an α-amino group of another amino acid. As such, the term “peptide” generically encompasses oligopeptides, polypeptides and proteins.

The term “oligopeptide” as used herein refers to peptides with fewer than about 10 to 20 residues, i.e., amino acid monomeric units.

The term “polypeptide” as used herein refers to peptides with more than 10 to 20 residues.

The term “protein” as used herein refers to polypeptides of specific sequence of more than about 50 residues.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single-stranded nucleotide multimers of from about 10 to about 100 nucleotides and up to 200 nucleotides in length.

The term “polynucleotide” as used herein refers to single- or double-stranded polymers composed of nucleotide monomers of generally greater than about 100 nucleotides in length.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other polynucleotides which are C-glycosides of a purine or pyrimidine base, polypeptides (proteins), polysaccharides (starches, or polysugars), and other chemical entities that contain repeating units of like chemical structure. In the practice of the instant invention, oligomers will generally comprise about 2-50 monomers, preferably about 2-20, more preferably about 3-10 monomers.

The term “monomer” as used herein refers to a chemical entity that can be covalently linked to one or more other such entities to form a polymer. Of particular interest to the present application are nucleotide “monomers” that have first and second sites (e.g., 5′ and 3′ sites) suitable for binding to other like monomers by means of standard chemical reactions (e.g., nucleophilic substitution), and a diverse element which distinguishes a particular monomer from a different monomer of the same type (e.g., a nucleotide base, etc.). In the art synthesis of nucleic acids of this type utilizes an initial substrate-bound monomer that is generally used as a building-block in a multi-step synthesis procedure to form a complete nucleic acid.

An “array,” or “chemical array” used interchangeably includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

Any given substrate may carry one, two, four or more or more arrays disposed on a front surface of the substrate. Depending upon the use, any or all of the arrays may be the same or different from one another and each may contain multiple spots or features. A typical array may contain more than ten, more than one hundred, more than one thousand more ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features). Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, light directed synthesis fabrication processes are used. It will be appreciated though, that the interfeature areas, when present, could be of various sizes and configurations. Each array may cover an area of less than 100 cm², or even less than 50 cm², 10 cm² or 1 cm². In many embodiments, the substrate carrying the one or more arrays will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays may be fabricated using drop deposition from pulse jets of either precursor units (such as nucleotide or amino acid monomers) in the case of in situ fabrication, or the previously obtained biomolecule, e.g., polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. Other drop deposition methods can be used for fabrication, as previously described herein.

In those embodiments where an array includes two more features immobilized on the sample surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one which is to be evaluated by the other (thus, either one could be an unknown mixture of analytes, e.g., polynucleotides, to be evaluated by binding with the other).

“Hybridizing” and “binding”, with respect to polynucleotides, are used interchangeably.

The term “substrate” as used herein refers to a surface upon which marker molecules or probes, e.g., an array, may be adhered. Glass slides are the most common substrate for biochips, although fused silica, silicon, plastic and other materials are also suitable.

When two items are “associated” with one another they are provided in such a way that it is apparent one is related to the other such as where one references the other. For example, an array identifier can be associated with an array by being on the array assembly (such as on the substrate or a housing) that carries the array or on or in a package or kit carrying the array assembly. “Stably attached” or “stably associated with” means an item's position remains substantially constant where in certain embodiments it may mean that an item's position remains substantially constant and known.

“Rigid” refers to a material or structure which is not flexible, and is constructed such that a segment about 2.5 by 7.5 cm retains its shape and cannot be bent along any direction more than 60 degrees (and often not more than 40, 20, 10, or 5 degrees) without breaking. “Compliant” refers to a material or structure that conforms or adapts upon application of an external force to it, but does not break, in contrast to a rigid material. For example, a compliant material is a material that, upon application of an external force, will undergo a change in its configuration, e.g., it will be compressed to assume a new configuration.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

“Stringent hybridization conditions” and “stringent hybridization wash conditions” in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCI, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions which determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

“Contacting” means to bring or put together. As such, a first item is contacted with a second item when the two items are brought or put together, e.g., by touching them to each other.

“Separating” means to move apart.

“Depositing” means to position, place an item at a location-or otherwise cause an item to be so positioned or placed at a location. Depositing includes contacting one item with another. Depositing may be manual or automatic, e.g., “depositing” an item at a location may be accomplished by automated robotic devices.

By “remote location,” it is meant a location other than the location at which the array (or referenced item) is present and hybridization occurs (in the case of hybridization reactions). For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart.

“Communicating” information references transmitting the data representing that information as signals (e.g., electrical, optical, radio signals, etc.) over a suitable communication channel (e.g., a private or public network).

“Forwarding” an item refers to any means of getting that item from one location to the next, whether by physically transporting that item or otherwise (where that is possible) and includes, at least in the case of data, physically transporting a medium carrying the data or communicating the data.

A “well” references a partially enclosed volume that is defined by a bottom wall and side walls but is not entirely covered, where a well can hold a volume of a liquid. A “chamber” references an enclosed volume (although a chamber may be accessible through one or more ports). It will also be appreciated that throughout the present application, that words such as “top,” “upper,” and “lower” are used in a relative sense only.

It will also be appreciated that throughout the present application, that words such as “cover”, “base” “front”, “back”, “top”, are used in a relative sense only. The word “above” used to describe the substrate and/or flow cell is meant with respect to the horizontal plane of the environment, e.g., the room, in which the substrate and/or flow cell is present, e.g., the ground or floor of such a room.

The term “sample” as used herein relates to a material or mixture of materials, typically, although not necessarily, in fluid form, containing one or more components of interest.

The term “hybridization solution” or “hybridization reagent” used herein interchangeably refers to a solution suitable for use in a hybridization reaction.

The terms “mix” and “mixing” as used herein means to cause fluids to flow within a volume so as to more uniformly distribute solution components, as after different solutions are combined or after a solution is newly introduced into a volume or after a component of the solution is locally depleted.

The term “seal” refers to a tight closure that prevents the passage of gas or water from one side of the closure to the other.

The term “integral with” means joined, e.g., connected or bonded to, or, in other embodiments, made at the same time as. In other words, in certain embodiments, if a first element is molded into a second element, the first element may be integral with the second element.

### DETAILED DESCRIPTION

Aspects of the invention include systems for producing microarray assay devices. The systems include a base support, a well-defining structure and a first compression element, where these components are configured to be assembled together with a planar microarray to produce a microarray assay device. The resultant microarray assay device includes two or more distinct fluid tight wells which have a bottom surface that is a region of the top surface of the planar microarray. Embodiments of the systems further include a cover and a second compression element. Further aspects of the invention include assembled microarray assay devices, as well as methods of assembling the devices and methods of using the assembled devices.

Before the present invention is described in greater detail, it is to be understood that this invention is not limited to particular embodiments described herein. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood in the art to which this invention belongs. Although any methods and materials similar or equivalent to those described herein can also be used in the practice or testing of the present invention, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

As used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Each of the individual embodiments described and illustrated herein has discrete components and features which may be readily separated from or combined with the features of any of the other several embodiments without departing from the scope of the present invention. Any recited method can be carried out in the order of events recited or in any other order which is logically possible.

As summarized above, aspects of the invention include systems that can be used, along with a planar microarray or arrays, to produce a microarray assay device. Embodiments of the systems include: a) a base support configured to hold a planar microarray, e.g., in a portion thereof; b) a well-defining structure configured to be positioned on an upper surface of a planar microarray to define two or more distinct wells on said upper surface of said planar microarray, wherein said well-defining structure comprises a compliant bottom portion and a rigid upper portion; and c) a first compression element. The first compression element is configured to (i) apply a uniform downward force onto said upper portion of said well-defining structure that is sufficient to produce two or more fluid tight wells defined by said well-defining structure and said upper surface of said planar microarray; and (ii) provide an unobstructed access to said two or more fluid tight wells. Embodiments of each of these components is now reviewed in greater detail with respect to figures.

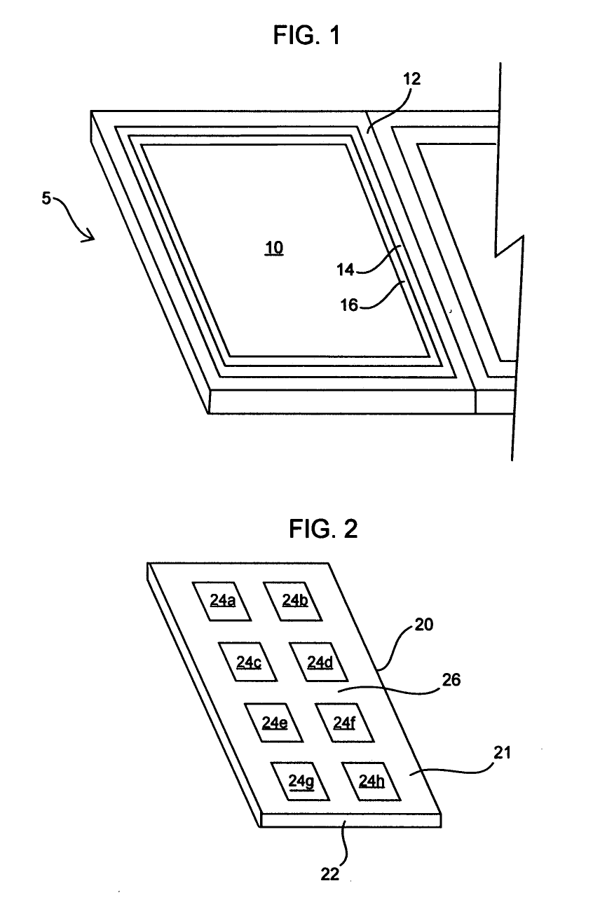

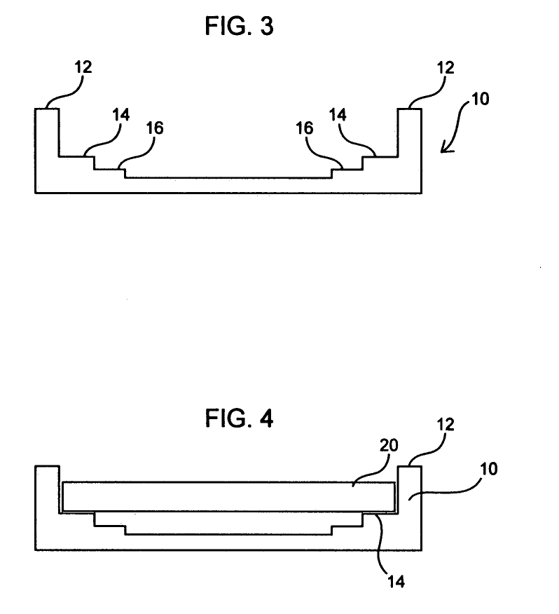

FIG. 1 provides a three-dimensional view of a portion 10 of a base support 5 according to any embodiment of the invention. The portion 10 of base support 5 is configured to hold a planar microarray, e.g., as shown in FIG. 2. The total base support may be configured to hold a number of different arrays, e.g., 2 or more, 3 or more, 4 or more, etc. With respect to FIG. 1, base support is a rigid structure that is rectangular in structure. While the dimensions of the support may vary, in certain embodiments the base support as a length that ranges from 1 to 100 cm, such as 2.54 to 7.62 cm, a width that ranges from 1 to 100 cm, such as 2.54 to 7.62 cm, and a height the ranges from 0.05 to 0.2 cm, such as 0.095 to 0.105 cm. In certain embodiments, the base support is dimensioned such that, upon use with other components of the system to produce a microarray assay device, it can be used with automated handling devices that are configured to work with standard 96-well microtitre plates, i.e., the overall system that includes the base support has what is known in the art as an “SBS standard footprint design.”

Base support portion 10 includes upper surface 12. Inside of base support portion 10 is first step 14 which extends along the inner perimeter of the base support as shown. The first step 14 is positioned in a distance below the upper surface 12 so as to serve as a retaining mechanism and support for the planar microarray. In certain embodiments, this distance ranges from 0.1 to 2 mm, such as 0.5 to 1 mm. The width of first step 14 may vary, and ranges in instances from 0.5 to 2 mm, such as 0.9 to 1.1 mm. Where desired, the base support portion 10 may include additional step 16 (as well as others) that is configured to provide support for different dimensioned planar microarrays. In this manner, a base support may be configured to hold different dimensioned microarrays, and therefore be adapted for use with planar microarrays of differing dimensions.

FIG. 2 provides a three dimensional view of a planar microarray according to an embodiment of the invention. The planar microarray includes substrate 22 having an upper surface 21 on which are present multiple distinct addressable biopolymeric arrays. FIG. 2 shows eight addressable arrays, 24a to 24h. Each addressable biopolymeric array is made up of a plurality of distinct biopolymeric features, e.g., as described above. Also shown are interarray regions, e.g., 26, which separate any given array from any other given array on surface 21. The width of these regions may vary, and in certain embodiments ranges from 1 to 10 mm, such as 2 to 3 mm.

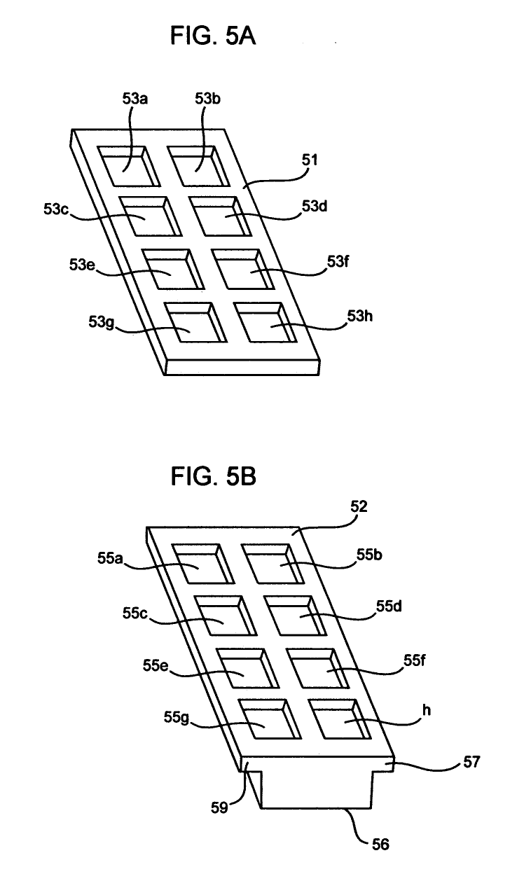

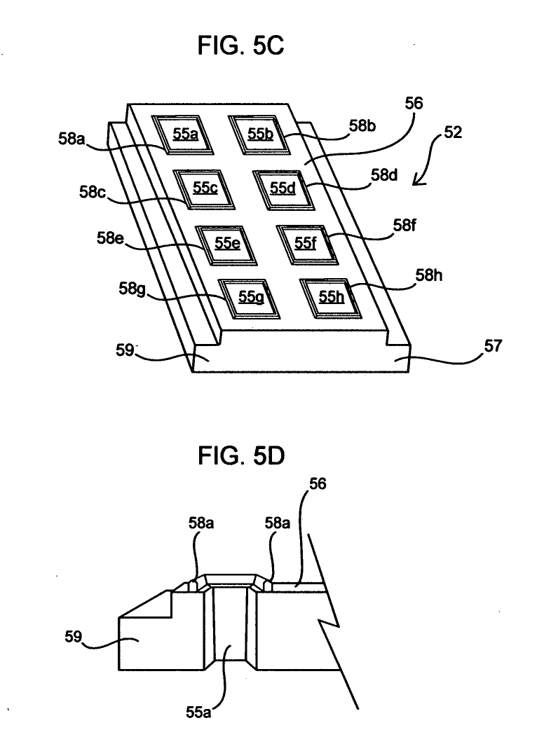

FIG. 3 provides a side view of the embodiment of the base support portion 10 shown in FIG. 1. FIG. 4 provides a view of the base support portion 10 shown in FIG. 3 into which the planar microarray 20 shown in FIG. 2 has been positioned. Planar microarray 20 rests on step 14 and supported thereby.

The systems of the invention further include a well-defining structure configured to be positioned on an upper surface of a planar microarray and, when placed on the upper surface of the planar microarray, e.g., surface 21 in the planar microarray shown in FIG. 2, to define two or more distinct wells on the upper surface of the planar microarray. The number of wells that a given well-defining structure may define in conjunction with a planar microarray depends (at least in certain embodiments) on the type of array for which the well-defining structure is configured for use. A given well-defining structure may be configured to define (in conjunction with a surface of a planar microarray) two or more wells, such as 4 or more, eight or more, 16 or more, 32 or more, 64 or more, 96 or more, etc, wells, as desired. Aspects of the well-defining structures include a compliant bottom portion and a rigid upper portion. The different portions of the well-defining structure may be provided by disparate components, e.g., by a compliant gasket and rigid wall structure, or the different portions may be integral with each other, such that the well-defining structure is an integrated structure having a compliant bottom portion and a rigid upper portion.

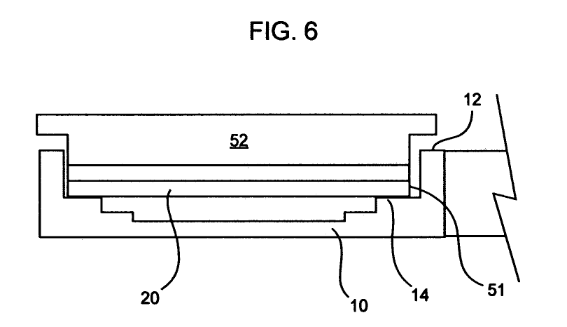

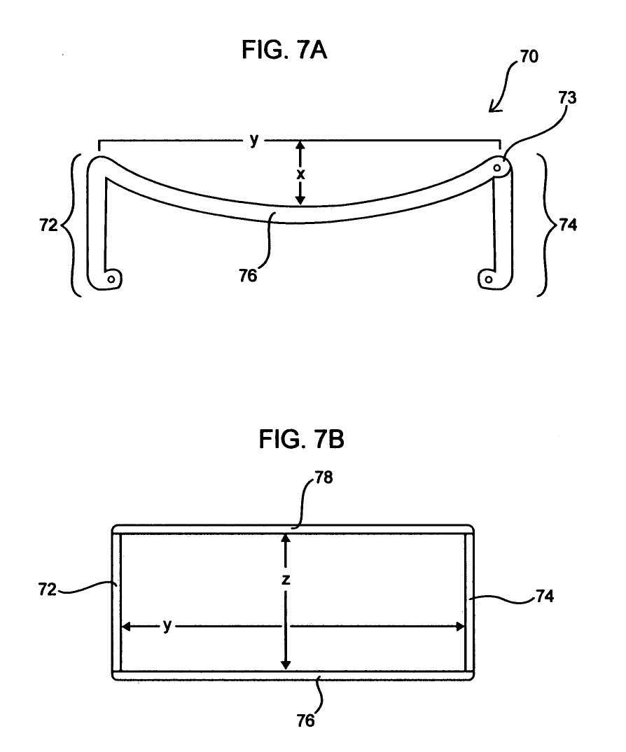

FIGS. 5A and 5B provide views of a gasket 51 and a rigid wall structure 52 which during use collectively make up a well-defining structure according to an embodiment of the invention. Gasket 51 is fabricated from a compliant material. Since gasket 51 is configured to be employed with the 8-array planar microarray shown in FIG. 2, gasket 51 includes eight different spaces, 53a to 53h, which are dimensioned to line up with the different arrays of planar microarray 20 of FIG. 2. While the dimensions of compliant gasket 51 may vary, in certain embodiments the compliant gasket has a length that ranges from 1 to 10 cm, such as 2.54 to 7.62 cm, a width that ranges from 1 to 12.7 cm, such as 12.7 to 7.62 cm, and a height the ranges from 0.5 to 4 mm, such as 0.8 to 1.6 mm. In the embodiment shown in FIG. 5A, each space 53a to 53h has a length ranging from 5 to 60 mm, such as 7 to 10 mm and a width ranging from 5 to 20, such as 7 to 10 mm.

Rigid wall structure 52 is fabricated from a rigid material. Since rigid wall structure 52 is configured to be employed with the 8-array planar microarray shown in FIG. 2, rigid wall structure 52 includes eight different passages, 55a to 55h, which are dimensioned to line up with the different arrays of planar microarray 20 of FIG. 2 and different spaces 53a to 53h of gasket 51. While the dimensions of rigid wall structure 51 may vary, in certain embodiments the rigid wall structure has dimensions that match those of the gasket above. Also present on rigid wall structure 52 are side overhangs 57 and 59. Overhangs 57 and 59 extend beyond dimensions of the lower surface 56 by a distance ranging from 1 to 5 mm, such as 2 to 4 mm.

FIG. 5C provides a view of the lower surface 56 of rigid wall structure 52, so as to provide a view of the underside of rigid wall structure 52. As shown in FIG. 5C, each passage 55a to 55h is surrounded by a ridge 58a to 58h that encircles its corresponding passage. Another view of ridge 58a on lower surface 56 of rigid wall structure 52 is shown in FIG. 5D. FIG. 5D provides a cutaway view through passage 55a. While the dimensions of ridge 58a (as well as ridges 58b to 58h) may vary, in certain embodiments the ridges have a height ranging from 0.5 to 2 mm, such as 1 to 1.5 mm and a width ranging from 0.5 to 2 mm, such as 0.8 to 1.5 mm. In certain embodiments, analogous ridges are present on the top and bottom of the well structure.

In certain embodiments, the rigid wall structure includes analogous ridges on its upper surface. In these embodiments, the dimensions of the ridges may vary, and in certain-embodiments the ridges have a height ranging from 0.5 to 2 mm, such as 0.8 to 1.5 mm and a width ranging from 0.5 to 2 mm, such as 0.8 to 1.5 mm.

While the embodiments shown in FIGS. 5A to 5D are well-defining structures made up of disparate components, e.g., a gasket and a rigid wall structure, in certain embodiments, the well-defining structure is an integrated unit, having a compliant bottom portion and a rigid upper portion. Integrate structure can be fabricated using any convenient protocol, e.g., by adhering a gasket to the bottom surface of a rigid wall structure using a suitable adhesive.

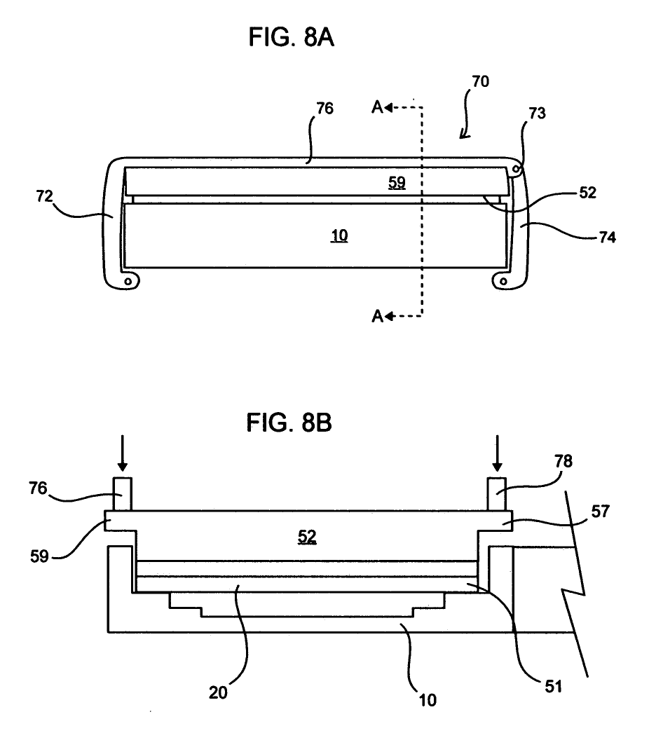

FIG. 6 provides an end on view of a subassembly of a device according to an embodiment of the invention, where planar microarray 20 has been placed into base support portion 10 so that it rests on ledge or step 14. Positioned on top of planar microarray 10 is gasket 51, and positioned on top of gasket 51 is rigid wall structure 52. Collectively, gasket 51 and rigid wall structure 52 may be viewed as a well-defining structure.

Following positioning of the planar microarray and well-defining structure into the base support, e.g., as shown in FIG. 6, the well-defining structure is compressed onto the upper surface of the planar microarray in a manner sufficient to produce fluid tight wells which are defined by the passage and space elements of the rigid wall structure and gasket and the upper surface of the planar microarray. As such, the well-defining structure and the upper surface of the planar microarray are compressed together, e.g., by applying a downward force onto the well-defining structure relative to the planar microarray, to produce a fluid tight seal at the interface between the well-defining structure and the upper surface of the planar microarray.

Any convenient compression element or combination of elements may be employed to compress the well-defining structure onto the surface of the planar microarray. Compression elements of interest include, but are not limited to: clamps, screws, snap-fit structures, etc.

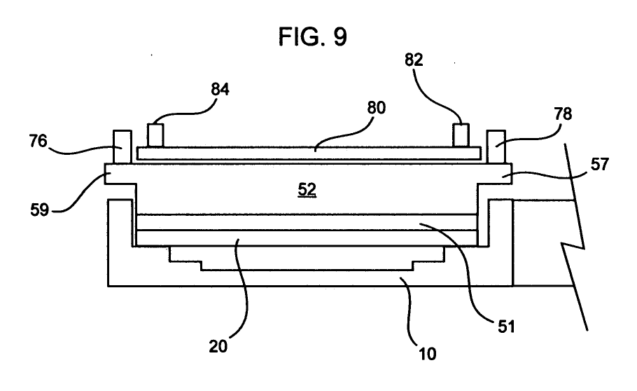

In certain embodiments, a compression element is employed that is configured to: apply a uniform downward force onto the upper portion of the well-defining structure that is sufficient to produce two or more fluid tight wells defined by the well-defining structure and the upper surface of the planar microarray; and provide an unobstructed access to the two or more fluid tight wells. An example of such a compression element is a bowed spring clamp, e.g., as depicted in FIG. 7A. In FIG. 7A, bowed spring clamp 70 includes a first end securing element 72 configured to secure the clamp to a first end of a base support, e.g., base support 20 as shown in FIG. 1, a second end securing element 74 configured to secure the clamp to a second end of a base support e.g., base support 20 as shown in FIG. 1; and a spring section element 76 joining the first and second securing elements. FIG. 7B shows a top view of the clamping element 70. As can be seen in FIG. 7B, the securing elements 72 to 74 are joined to each other by two parrallel bowed spring side elements, 76 and 78. In the embodiment shown in these figures, the clamping element 72 and bowed spring clamp element 76 are components of the same part. The second clamping element 74 is a separate part and is attached to the bowed spring clamp with a dowel to act as a hinge point for the second hinge clamp. The two spring clamp sections on the other end are attached with a dowel to maintain the same separation distance as with the hinged clamp 74. As such, the bowed spring clamp 70 includes first and second side elements 76 and 78 joining said first and second end securing elements. Joining the securing element 74 to side elements 76 and 78 is a hinge 73 in order, which may or may not be present depending on a particular embodiment. The dimensions of this spring clamp assembly are such that the distance between the two bowed spring clamps match the overhangs on the rigid well structure. And the distance between the two clamping ends are such that they extend to just past the length of the rigid well structure. Because of the design on this bowed spring clamping element, the clamping element in no way obstructs access to resultant wells of the device that is produced upon assembly of the structure. The clamping element does not obstruct the wells because it is compresses the well-defining structure along the upper sides of the well-defining structure, e.g., on the overhangs of the well-defining structure.

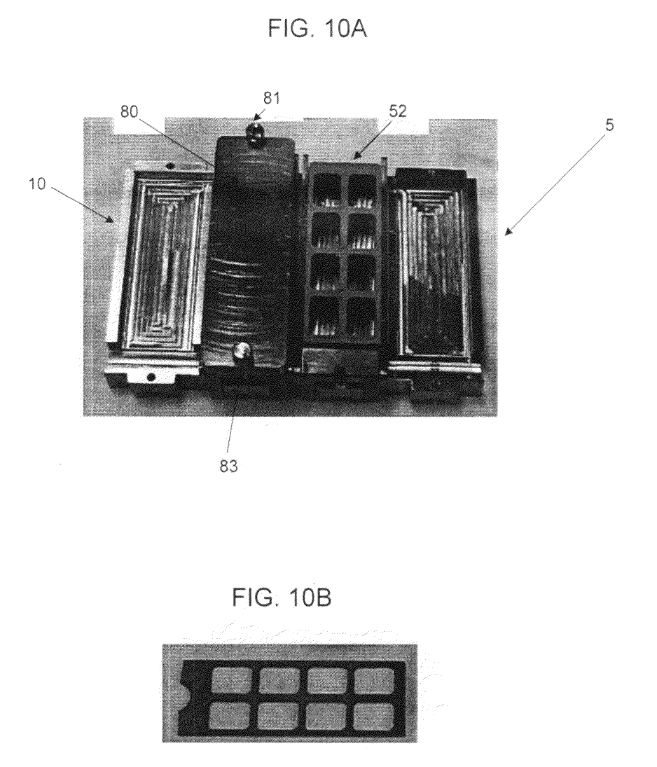

FIGS. 8A and 8B provide views of an assembled structure. In FIG. 8A, an end view of an assembled structure is provided, showing base support portion 10 having well rigid wall structure 52 positioned therein and secured into place (such that it is. immobilized relative to the planar microarray (hidden) compression element 70. As can be seen in FIG. 8A, securing element 72 secures the compression element to one side of base support portion 10 and securing element 74 secures the compression element to the other side of base support portion 10. The bowed spring portion 76 of the clamping element is now linearized and exerts uniform downward force on the upper surface of the rigid wall structure 52, and specifically along the length of overhang 59. FIG. 8B provides a view along dashed line A-A as shown in FIG. 8A. The configuration of the compression element may vary, and in certain embodiments is configured to provide a downward force sufficient to provide a tight seal against the array surface.

The assemble structure provides 2 or more fluid tight wells. The volume of the provided wells may vary, ranging in certain embodiments from 20 to 1000 microliters, such as from 50 to 200 microliters.

In certain embodiments, it is desirable to provide a structure in which the two or more fluid tight wells are covered, so as to produce chambers. In such embodiments, the system includes a cover. The cover may be fabricated from a rigid or flexible material (or be a composite of such materials) as desired. For composite structures, the cover may have a compliant bottom region and a rigid upper region, where the two regions may be provided by disparate components or be integral, e.g., in a manner analogous to the well-defining region as described above. The dimensions of the cover may vary, and in certain embodiments the dimensions are selected to approximate or match the dimensions of the well-defining structure.

Where the system includes a cover, in certain embodiments the system further includes a securing element(s) that secures the cover to the rest of the assembly. Any convenient securing element(s) may be employed, including but not limited to: clamps, snap-fit structures, screws, etc. In certain embodiments, this securing element is a second compression element configured to apply a uniform downward force onto an upper surface of the cover to produce two or more sealed chambers, where the two or more sealed chambers are fluid tight and are defined by: upper surface of said planar microarray; the well-defining structure and the cover. In certain of these embodiments, this second compression element is a bowed spring compression element which is analogous to the first bowed spring compression element described above, with the only difference that it is dimensioned to be used in conjunction with the first compression element and apply a downward force to the cover.

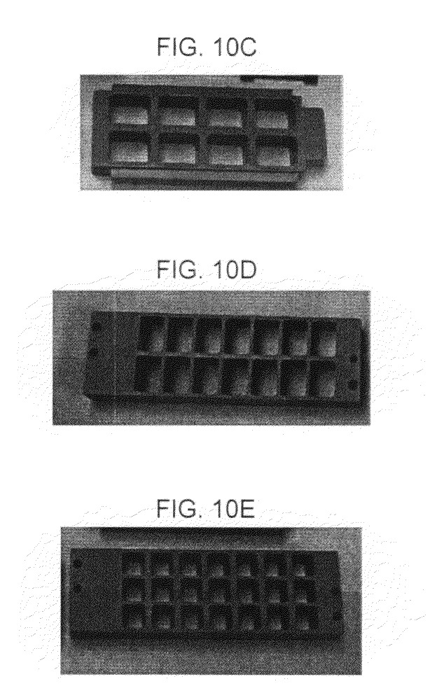

FIG. 9 provides an end on view of the assembly shown in FIG. 8B, where a cover and second compression element have been included in the assembly to provide for sealed reaction chambers defined by the upper surface of the planar microarray, the walls of the well-defining structure and the bottom surface of the cover. In FIG. 9, positioned on top of rigid wall structure 52 is cover 80. Cover 80 is forced downward onto rigid wall structure, and therefore immobilized relative to the rigid wall structure 52, by the bowed spring joining arms 82 and 84 of a second compression element.

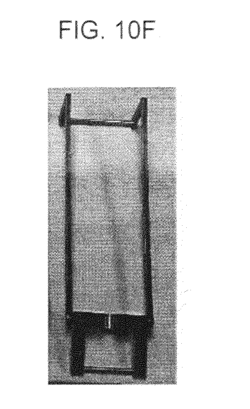

FIGS. 10A to 10F provides digital images of various components of a system according to an embodiment of the invention. FIG. 10A shows base support 5 with base support portion 10 at one end. The base support 5 includes 3 additional portions that are identical to 10, and is dimensioned to have a standard microtitre footprint. Also shown is rigid wall structure 52 which is positioned in one of the portions and rests on a gasket (hidden). Also shown is cover 80 which is secured to the rest of the assembly by screws 81 and 83. FIG. 10B provides a view of a gasket designed for use in the system shown in FIG. 10A. FIGS. 10C, 10D and 10E provide views of various rigid wall structures having differing numbers of passageways that can be employed with the system shown in FIG. 10A, e.g., so that the system can be adaptable to different multiarray formats. FIG. 10F provides a view of a bowed spring compression element that is configured for use in the system shown in 10A.

Variations of the above-described specific embodiments are also within the scope of the invention. As indicated above, the dimensions of the overall assembly may vary greatly, where in certain embodiments the overall assembly is chosen to have standard microtitre footprint. In such embodiments, the assembled structures are readily usable with automated microtitre plate experimental handling systems. The number of wells defined by a given system and/or the number of different arrays that may be positioned in a system may also vary.

The various components of the systems may be fabricated from a variety of materials. For rigid structures or elements of interest, are materials that will not substantially interfere with the assay reagents and will have minimal non-specific binding characteristics, e.g., substantially chemically inert, thermally stable, etc. Accordingly, of interest are materials that are chemically and physically stable under conditions employed for array assay procedures. Examples of such materials include, but are not limited to, plastics such as polytetrafluoroethylene, polypropylene, polystyrene, polycarbonate, PVC, and blends thereof, stainless steel and alloys thereof, siliceous materials, e.g., glasses, fused silica, ceramics and the like. In those embodiments where the assemblies or components thereof may also be compatible and thus used with an array reader or scanner, the material used will be compatible with the reader as well. For example, where the reader is an optical scanner, the material may be opaque, such as an opaque plastic, e.g., black acrylonitrile-butadiene-styrene (ABS) plastic (although other materials could be used as well). Carbon filled polypropylene.

Compliant structure, e.g., gaskets, may also be fabricated from any convenient material. Suitable materials include flexible materials having a hardness Durometer between 20 and 80 Shore A, such as between 30 and 40 Shore A hardness. Of interest are silicone rubber and various formulations of silicone rubber. Of interest may also be flexible plastic such as a polyolefin film (such as polypropylene, polyethylene, polymethylpentene), polyetheretherketone, polyimide, any of the fluorocarbon polymers or other suitable flexible thermoplastic polymer films, etc.

For certain components, adhesives may be employed, e.g., to bond a gasket to a rigid wall structure to provide an integrated well-defining structure. Any convenient adhesive may be employed. Adhesives of interest include, but are not limited to: time and temperature cure type epoxies and UV cure epoxies. Examples of epoxies useful for the invention are Dymax UV cure epoxies 3011 manufactured by Dymax Corporation of Torrington, Conn.; 3M DP 460 and 3M DP-190, both of 3M Corporation, Minn.; and Loctite U-10FL of Loctite Corporation, Cleveland, Ohio. Adhesive compositions of interest are further described in United States Patent Application Serial No. 20030113724, the disclosure of which is herein incorporated by reference.

The various components of the systems may be fabricated using any convenient protocol, such as, but not limited to, molding, machining, laser ablation, etc. In one embodiment, a double shot molding process is employed, where the rigid well structure and the compliant gasket material are molded together.

The structures assembled from the systems reviewed above are microarray assay devices. Embodiments of these devices include at least: a base support configured to hold a planar microarray; a planar microarray present in the base support; a well-defining structure positioned on an upper surface of the planar microarray to define two or more distinct wells on the upper surface of the planar microarray, wherein the well-defining structure comprises a compliant bottom portion and a rigid upper portion; and a first compression element applying a uniform downward force onto the rigid upper portion of the well-defining structure that is sufficient to produce two or more fluid tight wells defined by said well-defining structure and said upper surface of said planar microarray, wherein said first compression element provides an unobstructed access to the two or more fluid tight wells.

The above structures may be assemble from the systems by placing a planar microarray into a base support configured to hold a the planar microarray; positioning a well-defining structure on an upper surface of the planar microarray to define two or more distinct wells on the upper surface of the planar microarray; and applying a uniform downward force onto said rigid upper portion of the well-defining structure in a manner sufficient to produce two or more fluid tight wells defined by the well-defining structure and said upper surface of said planar microarray. This downward force may be applied with a first compression element, e.g., one that provides an unobstructed access to the two or more fluid tight wells. Following assembly of this device, a liquid sample may be positioned in at least one of the fluid tight wells. The liquid sample may be positioned in (i.e., introduced to) at least one of the fluid tight wells using any convenient fluid introduction protocol, including automated and manual protocols.

In certain embodiments, the devices further include a cover positioned over the rigid upper portion of the well-defining structure. The device may also include a second compression element applying a downward force onto an upper surface of the cover to produce two or more sealed chambers defined by: the upper surface of the planar microarray; the well-defining structure and the cover. When the devices include a cover, assembling such devices includes positioning a cover over an upper surface of the well defining structure. In these embodiments, the methods may further include applying a downward force onto an upper surface of the cover with a second compression element to produce two or more sealed chambers defined by: the upper surface of said planar microarray; the well-defining structure and the cover.

The arrays present in each well or chamber of the device (depending on the embodiment) may vary. The-arrays are, in certain instances, addressable biopolymeric arrays, e.g., addressable nucleic acid or peptide arrays, such as described above.

As summarized above, methods are also provided for performing an array-based assay, such as a hybridization assay or any other binding interaction assay. Generally, a sample suspected of including an analyte of interest, i.e., a target molecule, is introduced into a well of the device and thereby contacted with an array on the bottom of the well. Where desired, the well is covered to provide a sealed assay chamber. The well/chamber is maintained under conditions sufficient for the analyte target in the sample to bind to its respective binding pair member that is present on the array. Thus, if the analyte of interest is present in the sample, it binds to the array at the site of its complementary binding member and a complex is formed on the array surface. The presence of this binding complex on the array surface is then detected, e.g., through use of a signal production system, e.g., an isotopic or fluorescent label or the like present on the analyte, as described above. The presence and/or amount of the analyte in the sample is then deduced from the detection of binding complexes on the substrate surface.

Specific analyte detection applications of interest include hybridization assays in which the nucleic acid arrays of the subject invention are employed. In these assays, a sample of target nucleic acids is first prepared, where preparation may include labeling of the target nucleic acids with a label, e.g. a member of signal producing system. Following sample preparation, the sample is contacted with the array under hybridization conditions (e.g., stringent conditions), whereby complexes are formed between target nucleic acids that are complementary to probe sequences attached to the array surface. The presence of hybridized complexes is then detected. Specific hybridization assays of interest which may be practiced using the subject arrays include: gene discovery assays, differential gene expression analysis assays; nucleic acid sequencing assays, comparative genomic hybridization assays, immuno-precipitation assays, ChIP-on Chip assays and the like. Patents and patent applications describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992. Also of interest are U.S. Pat. Nos. 6,656,740; 6,613,893; 6,599,693; 6,589,739; 6,587,579; 6,420,180; 6,387,636; 6,309,875; 6,232,072; 6,221,653; 6,180,351, and 6,410,243. In certain embodiments, the subject methods include a step of transmitting data from at least one of the detecting and deriving steps, as described above, to a remote location.

Where the arrays are arrays of peptide binding agents, e.g., protein arrays, specific applications of interest include analyte detection/proteomics applications, including those described in U.S. Pat. Nos. 4,591,570; 5,171,695; 5,436,170; 5,486,452; 5,532,128 and 6,197,599 as well as published PCT application Nos. WO 99/39210; WO 00/04832; WO 00/04389; WO 00/04390; WO 00/54046; WO 00/63701; WO 01/14425 and WO 01/40803—the disclosures of which are herein incorporated by reference.

In using the array assay devices of embodiments of the present invention, in one embodiment, an array assay device having a plurality of wells, e.g., as depicted in FIG. 10A, is provided. A fluid sample e.g., biological sample suspected of containing target analyte, such as target nucleic acids, is then introduced in one or more of the wells of the device. The sample may be any suitable sample suspected of including an analyte of interest. The sample may include the target analyte, which may be pre-amplified and labeled. Thus, at some point prior to the detection step, described below, any target analyte present in the initial sample contacted with the array may be labeled with a detectable label. Labeling can occur either prior to or following contact with the array. In other words, the analyte, e.g., nucleic acids, present in the fluid sample contacted with the array may be labeled prior to or after contact, e.g., hybridization, with the array. In some embodiments of the subject methods, the sample analytes e.g., nucleic acids are directly labeled with a detectable label, wherein the label may be covalently or non-covalently attached to the nucleic acids of the sample. For example, the nucleic acids, including the target nucleotide sequence, may be labeled with biotin, exposed to hybridization conditions, wherein the labeled target nucleotide sequence binds to an avidin-label or an avidin-generating species. In an alternative embodiment, the target analyte such as the target nucleotide sequence is indirectly labeled with a detectable label, wherein the label may be covalently or non-covalently attached to the target nucleotide sequence. For example, the label may be non-covalently attached to a linker group, which in turn is (i) covalently attached to the target nucleotide sequence, or (ii) comprises a sequence which is complementary to the target nucleotide sequence. In another example, the probes may be extended, after hybridization, using chain-extension technology or sandwich-assay technology to generate a detectable signal (see, e.g., U.S. Pat. No. 5,200,314). Generally, such detectable labels include, but are not limited to, radioactive isotopes, fluorescers, chemiluminescers, enzymes, enzyme substrates, enzyme cofactors, enzyme inhibitors, dyes, metal ions, metal soils, ligands (e.g., biotin or haptens) and the like.

In one embodiment, the label is a fluorescent compound, i.e., capable of emitting radiation (visible or invisible) upon stimulation by radiation of a wavelength different from that of the emitted radiation, or through other manners of excitation, e.g. chemical or non-radiative energy transfer. The label may be a fluorescent dye. A target with a fluorescent label includes a fluorescent group covalently attached to a nucleic acid molecule capable of binding specifically to the complementary probe nucleotide sequence.

Following sample introduction, a cover is placed over the rigid wall structure and force applied thereto in a manner sufficient to convert the well into a sealed reaction chamber that includes the sample.

In certain embodiments, the protocol employed is one that yields sealed wells that are sufficiently tight or stable such that the seals prevent leakage from the well under normal hybridization conditions, which conditions include mixing and incubation at high temperatures. For example, the temperature range for hybridization may range from room temperature to 70° C., such as from 60 to 65° C. Seals provided in embodiments of the invention are sufficient to withstand these conditions and maintain their seal of the chambers.

Where desired, the sample may be mixed in an assay area of the internal space, where the fluid may be mixed using any convenient method such as shaking, turbulence, rotation, etc. In certain embodiments, the sample is contacted with the array substrate present in the internal space, e.g., as described above, under stringent conditions to form binding complexes on the surface of the substrate by the interaction of the surface-bound probe molecule and the complementary target molecule in the sample. In the case of hybridization assays, the sample is contacted with the array under stringent hybridization conditions, whereby complexes are formed between target nucleic acids that are complementary to probe sequences attached to the array surface, i.e., duplex nucleic acids are formed on the surface of the substrate by the interaction of the probe nucleic acid and its complement target nucleic acid present in the sample.

Following sample contact and incubation, the array substrate may be washed at least one time to remove any unbound and non-specifically bound sample from the substrate, where in certain embodiments at least two wash cycles are used. Washing agents used in array assays may vary depending on the particular binding pair used in the particular assay. For example, in those embodiments employing nucleic acid hybridization, washing agents of interest include, but are not limited to, salt solutions such as sodium, sodium phosphate and sodium, sodium chloride and the like as is known in the art, at different concentrations and may include some surfactant as well.

In washing the substrate and more specifically at least one array thereon, in certain embodiments a first wash is performed after the cover is removed and while the wells are still assembled. This substantially removes the hybridization solution and minimizes/eliminates any further binding to the array. The substrate may then be removed from the array assay device or may be washed while still positioned in the device. To remove the substrate from the array assay device, the downward force on the cover is removed, the cover is separated from the system, the compression element on the well-defining structure is released, the well-defining structure is removed and the planar microarray is separated from the base support. The separated planar microarray may then be washed using any convenient protocol. Alternatively, following removal of the cover, the array may be washed by introducing and removing wash fluid into the well that includes the particular array of interest.

Following the washing procedure, as described above, the array is then interrogated or read so that the presence of the binding complexes present on the surface thereof may be detected.

Reading of the array may be accomplished by illuminating the array and reading the location and intensity of resulting fluorescence at each feature of the array to detect any binding complexes on the surface of the array. For example, a scanner may be used for this purpose, such as the AGILENT MICROARRAY SCANNER available from Agilent Technologies, Palo Alto, Calif. Other suitable apparatus and methods are described in U.S. Pat. Nos. 5,091,652; 5,260,578; 5,296,700; 5,324,633; 5,585,639; 5,760,951; 5,763,870; 6,084,991; 6,222,664; 6,284,465; 6,371,370 6,320,196 and 6,355,934. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

In certain embodiments, the methods include a step of transmitting data from at least one of the detecting and deriving steps, as described above, to a remote location. By “remote location” is meant a location other than the location at which the array is present and hybridization occur. For example, a remote location could be another location (e.g., office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart. “Communicating” information means transmitting the data representing that information over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, internet, etc.

Aspects of the invention also include kits that include the systems of the invention and/or components thereof. The subject kits include one or more of the components of the systems, e.g., base supports, gaskets, rigid wall structures, compression elements, covers, etc. The kits may further include one or more additional components necessary for carrying out an analyte detection assay, such as sample preparation reagents, buffers, labels, microarrays, and the like. As such, the kits may include one or more containers such as vials or bottles, with each container containing a separate component for the assay, and reagents for carrying out an array assay such as a nucleic acid hybridization assay or the like. The kits may also include a denaturation reagent for denaturing the analyte, buffers such as hybridization buffers, wash mediums, enzyme substrates, reagents for generating a labeled target sample such as a labeled target nucleic acid sample, negative and positive controls and written instructions for using the subject array assay devices for carrying out an array based assay. The instructions may be printed on a substrate, such as paper or plastic, etc. As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. The kits may further include a cutting implement, e.g., for separating the array housing device into two pieces to provide for fluid access to the internal space, as described above.

Although the foregoing invention has been described in some detail by way of illustration and example for purposes of clarity of understanding, certain changes and modifications may be made thereto without departing from the scope of the appended claims.

What is claimed is:

1. A system comprising:
a) a base support configured to hold a planar microarray;
b) a well-defining structure configured to be positioned on an upper surface of a planar microarray to define two or more distinct wells on said upper surface of said planar microarray, wherein said well-defining structure comprises a compliant bottom portion and a rigid upper portion; and
c) a first compression element configured to:
(i) apply a uniform downward force onto said upper portion of said well-defining structure that is sufficient to produce two or more fluid tight wells defined by said well-defining structure and said upper surface of said planar microarray; and
(ii) provide an unobstructed access to said two or more fluid tight wells.

2. The system according to claim 1, wherein said well-defining structure comprises a compliant gasket and a rigid wall structure.

3. The system according to claim 2, wherein said rigid wall structure comprises a ridge on a bottom surface thereof.

4. The system according to claim 2, wherein said rigid wall structure comprises a ridge on a top surface thereof.

5. The system according to claim 1,wherein said well-defining structure comprises is an integrated structure.

6. The system according to claim 5, wherein said integrated structure comprises a ridge on a top surface thereof.

7. The system according to claim 1, wherein said system further comprises a cover configured to be positioned on an upper surface of said well-defining structure.

8. The system according to claim 7, wherein said system further comprises a second compression element configured to apply a uniform downward force onto an upper surface of said cover to produce two or more sealed chambers defined by:
said upper surface of said planar microarray;
said well-defining structure and
said cover.

9. The system according to claim 1, wherein said first compression element is a clamp comprising:
a first end securing element configured to secure said clamp to a first end of said base support;
a second end securing element configured to said clamp to a second end of said base support; and
first and second side elements joining said first and second end securing elements.

10. The system according to claim 9, wherein said first and second side elements are bowed.

11. A microarray assay device comprising:
a) a base support configured to hold a planar microarray;
b) a planar microarray present in said base support;
c) a well-defining structure positioned on an upper surface of said planar microarray to define two or more distinct wells on said upper surface of said planar microarray, wherein said well-defining structure comprises a compliant bottom portion and a rigid upper portion; and
d) a first compression element applying a uniform downward force onto said rigid upper portion of said well-defining structure that is sufficient to produce two or more fluid tight wells defined by said well-defining structure and said upper surface of said planar microarray, wherein said first compression element provides an unobstructed access to said two or more fluid tight wells.

12. The microarray assay device according to claim 11, wherein said device further comprises a cover positioned said rigid upper portion of said well-defining structure.

13. The microarray assay device according to claim 12, wherein said device further comprises a second compression element applying a downward force onto an upper surface of said cover to produce two or more sealed chambers defined by:
said upper surface of said planar microarray;
said well-defining structure and
said cover.

14. The microarray assay device according to claim 11, wherein said planar microarray comprises an addressable array of biopolymeric features on an upper surface of a rigid substrate.

15. The microarray assay device according to claim 14, wherein said biopolymeric features are nucleic acids.

16. The microarray assay device according to claim 14, wherein said biopolymeric features are peptides.

17. The microarray assay device according to claim 11, wherein said device further comprises a liquid sample present in at least one of said two or more distinct wells.

18. A method of producing microarray assay device, said method comprising:
a) placing a planar microarray into a base support configured to hold a said planar microarray;
b) positioning a well-defining structure on an upper surface of said planar microarray to define two or more distinct wells on said upper surface of said planar microarray, wherein said well-defining structure comprises a compliant bottom portion and a rigid upper portion; and
c) applying a uniform downward force onto said rigid upper portion of said well-defining structure with a first compression element in a manner sufficient to produce two or more fluid tight wells defined by said well-defining structure and said upper surface of said planar microarray, wherein said first compression element provides an unobstructed access to said two or more fluid tight wells.

19. The method according to claim 18, wherein said method further comprises introducing a liquid sample into at least one of said fluid tight wells.

20. The method according to claim 19, wherein said method further comprises positioning a cover over an upper surface of said well defining structure.

21. The method according to claim 20, further comprising applying a downward force onto an upper surface of said cover with a second compression element to produce two or more sealed chambers defined by:
said upper surface of said planar microarray;
said well-defining structure and
said cover.

22. A kit comprising:
a) a base support configured to hold a planar microarray;
b) a well-defining structure configured to be positioned on an upper surface of a planar microarray to define two or more distinct wells on said upper surface of said planar microarray, wherein said well-defining structure comprises a compliant bottom portion and a rigid upper portion; and
c) a first compression element configured to:
(i) apply a uniform downward force onto said upper portion of said well-defining structure that is sufficient to produce two or more fluid tight wells defined by said well-defining structure and said upper surface of said planar microarray; and
(ii) provide an unobstructed access to said two or more fluid tight wells.

23. The kit according to claim 22, wherein said kit further comprises a cover.

24. The kit according to claim 23, wherein said kit further comprises a second compression element configured to apply a uniform downward force onto an upper surface of said cover to produce two or more sealed chambers defined by:
said upper surface of said planar microarray;
said well-defining structure and
said cover.

25. The kit according to claim 22, wherein said kit further comprises a planar microarray.
